(19) United States
(12) Patent Application Publication
(10) Pub. No.: US 2026/0221771 A1
(43) Pub. Date: Jul. 30, 2026

(54) PLANT CONTROL DEVICE AND CALCULATION AMOUNT CHANGEABILITY DETERMINATION METHOD

(71) Applicant: Hitachi, Ltd., Tokyo (JP)

(72) Inventors: Yohei MURAKAMI, Tokyo (JP); Daisuke SHINMA, Tokyo (JP)

(21) Appl. No.: 19/414,378

(22) Filed: Dec. 10, 2025

(30) Foreign Application Priority Data
Dec. 26, 2024 (JP) 2024-229826

(51) Int. Cl. H02J 3/00; F02C 9/18

(52) U.S. Cl. CPC H02J 3/003; F02C 9/18; F05D 2260/821

(57) ABSTRACT

A plant control device according to one aspect of the present invention includes: a turbine bypass valve information collection unit that collects information on an opening degree of a turbine bypass valve in a nuclear power plant; an electric power demand information collection unit that collects information on an electric power demand of a consumer that uses electric power generated by the nuclear power plant; and a calculation amount changeability determination unit that determines whether or not the electric power demand of the consumer can be changed, based on the information on the opening degree of the turbine bypass valve and the information on the electric power demand, and outputs a determination result to the consumer.

### CROSS-REFERENCE TO RELATED APPLICATION

The present application claims priority from Japanese application JP 2024-229826, filed on Dec. 26, 2024, the content of which is hereby incorporated by reference into this application.

### BACKGROUND

### Technical Field

The present invention relates to a plant control device and a calculation amount changeability determination method.

### Related Art

In recent years, there is an increasing demand for nuclear power generation that can stably supply electric power and does not emit CO₂. For example, there is a trend to use nuclear power generation for data centers overseas. Furthermore, adjustment of an electric power generation amount matching a fluctuating demand is required for operations for data centers. However, nuclear power generation is generally operated at a rated output with a constant output. This is because an operation period taken until a fuel is taken out after the fuel is loaded once is determined in advance for the nuclear power generation. Hence, when control to lower an output from the rated output is performed for output adjustment, selling electricity chances are often lost.

For example, since a data center that uses generative Artificial Intelligence (AI) has characteristics that a fluctuation amount of a load (electric power demand) is large and a fluctuation speed is fast, output adjustment matching load fluctuation of the data center is requested even for nuclear power generation. Here, a behavior of load fluctuation in a data center will be described with reference to FIG. 1. FIG. 1 is a graph showing an example of the behavior of the load fluctuation in the data center.

In FIG. 1, a vertical axis represents a calculation amount of the load fluctuation in the data center, and a horizontal axis represents a time. When receiving a change start instruction 101 that is an instruction to reduce the calculation amount, the calculation amount in the data center continues decreasing until a change end instruction 102 is received. Hence, it is required that the output amount of the electric power on a nuclear power generation side is also adjusted so as to decrease following this fluctuation of the calculation amount.

In Japan, reserves possessed by nuclear power generation are classified into three types of a frequency containment reserve, a frequency restoration reserve, and a replacement reserve. The frequency containment reserve is a reserve that can cope with a response within 10 seconds, and the frequency restoration reserve is a reserve that can cope with a response within five minutes. Furthermore, the replacement reserve is a reserve that can cope with a response within 45 minutes.

A generator at a nuclear power plant is required to perform different control on each of these reserves. For example, the generator performs governor free control on the frequency containment reserve, and performs load frequency control on the frequency restoration reserve. Furthermore, economic load dispatching control is performed on the replacement reserve.

In the following description, the governor free control will be referred to as “GF (Governor Free) control”, the load frequency control will be referred to as LFC (Load Frequency Control) control, and the economic load dispatching control will be referred to as “EDC (Economic load Dispatching Control) control”.

The GF control is a control method for controlling an output of a power plant by an opening/closing operation of a governor in the power plant. That is, the GF control performs control matching a load fluctuation at a cycle of approximately several seconds to several minutes, mismatch between supply and demand, and the like. The LFC control is a control method where a central load dispatching office changes the output of the generator in response to a change in a system frequency, an interconnection line flow, or the like. The EDC control is a control method for changing an output of a power plant proactively in response to load fluctuation for a relatively long period of time such as several tens of minutes to several hours according to demand prediction.

For example, Patent Literature 1 discloses a cogeneration high-temperature gas-cooled reactor system that adopts an operation control system that fluctuates an output of a power plant in response to a request of a load side. The cogeneration high-temperature gas-cooled reactor system described in Patent Literature 1 includes first control means that adjusts a flow rate of a gas flowing through a bypass route between a nuclear reactor and a heat exchanger such that the temperature of the gas flowing into a turbine power generation system maintains a first control target value, and second control means that adjusts an inventory of the gas in a coolant circulation route such that the temperature of the gas flowing out from the nuclear reactor maintains a second control target value.

### Citation List

### Patent Literature

Patent Literature 1: JP 2012-57986 A

### SUMMARY

However, to support consumers such as data centers that use generative AI and whose load fluctuation amount is large and whose fluctuation speed is fast, it is required to perform control that can adjust the output of the power generator in a short cycle such as several seconds to several minutes for nuclear power generation. Such output adjustment in a short cycle can be performed by the above-described GF control. Opening and closing of the governor during the GF control is implemented by opening and closing a turbine bypass valve (hereinafter, referred to as a “TBV (Turbine Bypass Valve)”) of nuclear power generation.

However, it is not possible for a consumer side to grasp various pieces of information such as an operation state in the nuclear power plant, the opening degree of the TBV, and a speed at which the opening degree can be changed. Accordingly, there has been a problem that it is not possible for consumers to determine whether or not it is appropriate to change a load (electric power demand) that requires output adjustment of the nuclear power plant at a desired timing. There is also this problem similarly in a case where electric power supply demand targets of consumers are other power plants such as a thermal power plant. Furthermore, above-described Patent Literature 1 does not disclose a technique that enables the consumers to appropriately determine load change.

The present invention has been made to solve the above problem. An object of the present invention is to enable consumers that use electric power to be supplied from a power plant to appropriately determine whether or not electric power demands can be changed.

A plant control device according to an aspect of the present invention includes: a turbine bypass valve information collection unit that collects information on an opening degree of a turbine bypass valve in a power plant; an electric power demand information collection unit that collects information on an electric power demand of a consumer that uses electric power generated by the power plant; and an electric power demand changeability determination unit that determines whether or not the electric power demand of the consumer can be changed, based on the information on the opening degree of the turbine bypass valve and the information on the electric power demand, and outputs a determination result to the consumer.

According to the present invention, consumers that use electric power to be supplied from a power plant can appropriately determine whether or not electric power demands can be changed.

### BRIEF DESCRIPTION OF DRAWINGS

FIG. 1 is a graph showing an example of a behavior of load fluctuation in a conventional data center;

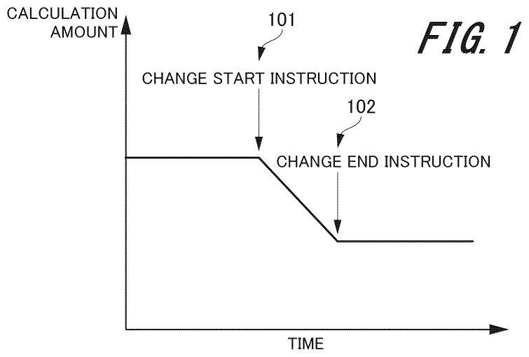

FIG. 2 is a diagram illustrating a schematic configuration example of a plant control system according to the first embodiment of the present invention;

FIG. 3 is a schematic view of each element related to the present embodiment in a nuclear power plant according to the first embodiment of the present invention;

FIG. 4 is a block diagram illustrating a hardware configuration example of the plant control system according to the first embodiment of the present invention;

FIG. 5 is a flowchart illustrating an example of a procedure of calculation amount changeability determination processing of a calculation amount changeability determination unit according to the first embodiment of the present invention;

FIG. 6 is a graph showing temporal changes of a calculation amount of a data center, an opening degree of a TBV, and an electric power generation amount of the nuclear power plant in a case where the calculation amount is changed in step S5 in FIG. 5 and an output is changed by opening and closing the TBV according to the first embodiment of the present invention, and FIG. 6 is a graph showing a transition of the calculation amount of the data center, FIG. 6 is also a graph showing a transition of the TBV opening degree, and FIG. 6 is also a graph showing a transition of the electric power generation amount of the nuclear power plant;

FIG. 7 is a diagram illustrating a schematic configuration example of a plant control system according to a second embodiment of the present invention;

FIG. 8 is a flowchart illustrating an example of a procedure of calculation amount changeability determination processing of a calculation amount changeability determination unit according to the second embodiment of the present invention;

FIG. 9 is a diagram illustrating a schematic configuration example of a plant control system according to a third embodiment of the present invention;

FIG. 10 is a flowchart illustrating an example of a procedure of calculation amount changeability determination processing of a calculation amount changeability determination unit according to the third embodiment of the present invention; and

FIG. 11 is a diagram illustrating a configuration example of an output adjustable value setting screen according to the third embodiment of the present invention.

### DETAILED DESCRIPTION

Hereinafter, embodiments of the present invention will be described in detail with reference to the drawings. In the description and the drawings, components having substantially the same functions or configurations are denoted by the same reference numerals, and redundant description will be omitted.

### 1. First Embodiment

### Configuration Example of Plant Control System

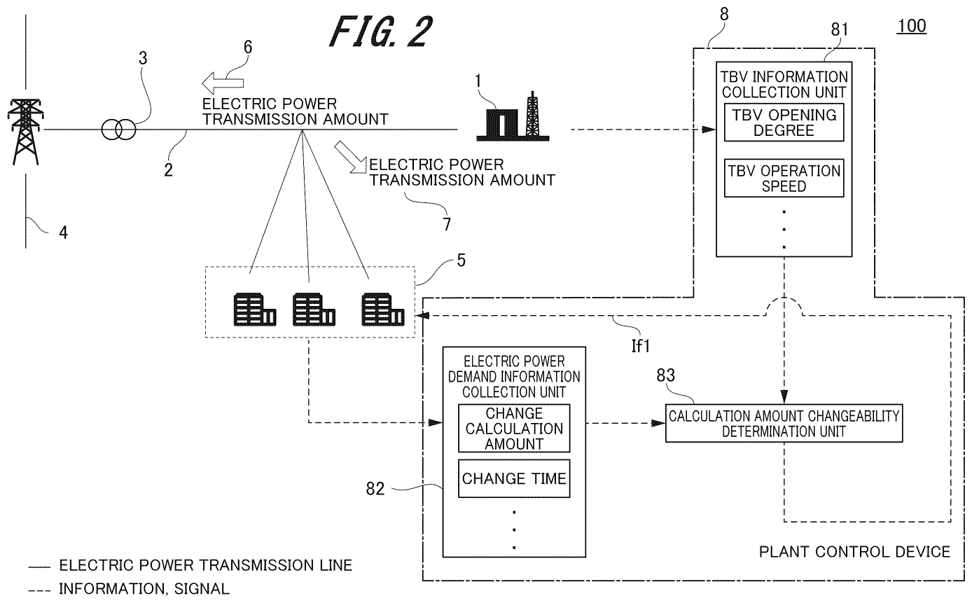

First, a configuration of a plant control system 100 according to the first embodiment of the present invention will be described. FIG. 2 is a diagram illustrating a schematic configuration example of the plant control system 100 according to the first embodiment of the present invention.

As illustrated in FIG. 2, the plant control system 100 includes a nuclear power plant 1 as an example of a plant and an external electric power system 4. The nuclear power plant 1 is a power plant that generates electric power by a nuclear power generation system. The external electric power system 4 is connected to the nuclear power plant 1 by an electric power transmission line 2 via a transformer 3, and electric power generated by the nuclear power plant 1 is transmitted to the external electric power system 4.

An electric power load 5 is installed at an intermediate point between the nuclear power plant 1 and the transformer 3. The electric power load 5 is a facility that can adjust a consumption amount of electric power supplied from the nuclear power plant 1.

The present embodiment will cite an example where the electric power load 5 is a data center. Furthermore, the data center as the electric power load 5 is also a consumer that requests and consumes generated electric power from the nuclear power plant 1.

Electric power of an electric power transmission amount 6 is transmitted from the nuclear power plant 1 to the external electric power system 4, and electric power of an electric power transmission amount 7 is transmitted to the electric power load 5. It is assumed that a total electric power generation amount of the electric power to be generated by the nuclear power plant 1 matches with a total of the electric power transmission amount 6 and the electric power transmission amount 7. In the present embodiment, the data center as the electric power load 5 is operated with the electric power to be supplied from the nuclear power plant 1. That is, it is assumed that the data center is operated in an off-grid mode that the data center is separated from the external electric power system 4.

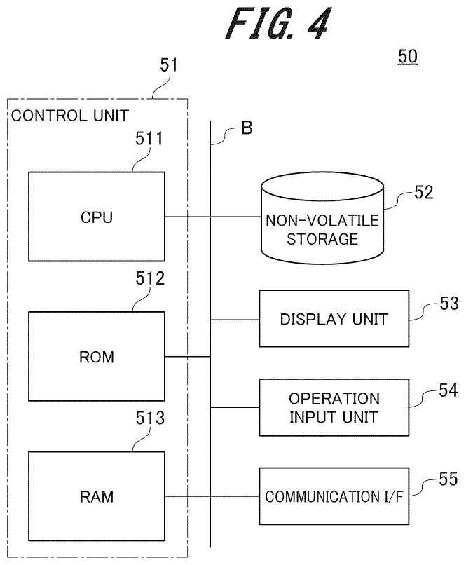

Furthermore, the plant control system 100 further includes a plant control device 8. The plant control device 8 includes a TBV information collection unit 81, an electric power demand information collection unit 82, and a calculation amount changeability determination unit 83. The TBV information collection unit 81 (an example of a turbine bypass valve information collection unit) collects information (hereinafter, also referred to as “TBV information”) such as an opening degree and an opening/closing (operation) speed of a TBV 202 (see FIG. 4) in the nuclear power plant 1.

The electric power demand information collection unit 82 collects information (hereinafter, also referred to as “electric power demand related information”) on a change amount of a calculation amount of an electric power load of the data center and a change time of the load (electric power demand). The calculation amount changeability determination unit 83 (an example of the electric power demand changeability determination unit) determines whether or not the calculation amount can be changed by a consumer based on the TBV information and the electric power related information (an example of information on the electric power demand), and outputs calculation amount changeability determination result information If1 as a determination result to the data center.

When the calculation amount can be changed, the calculation amount changeability determination result information If1 includes a calculation amount change signal for changing the calculation amount in the data center. Furthermore, the calculation amount in the data center is automatically changed based on the calculation amount changeability determination result information If1.

Note that the present embodiment assumes a mode that the consumer (data center) performs an off-grid operation that performs an operation with the electric power supplied from the nuclear power plant 1 alone, and therefore will cite an example where the calculation amount of the data center is automatically changed based on the calculation amount changeability determination result information If1. However, the present invention is not limited thereto. In a case where the consumer is a consumer that does not perform the off-grid operation, the calculation amount changeability determination unit 83 may output to the consumer the calculation amount changeability determination result information If1 including only information on whether or not the calculation amount can be changed.

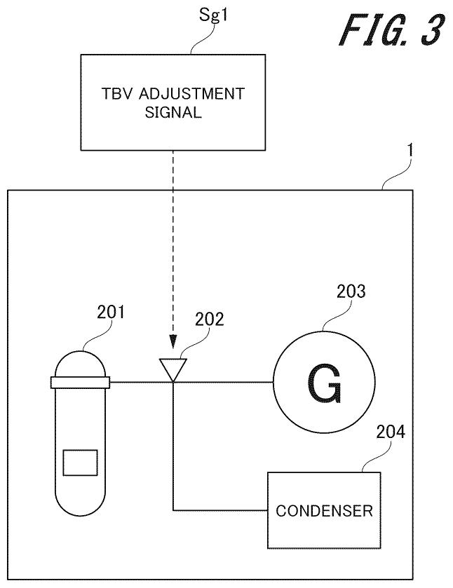

FIG. 3 is a schematic view of each element related to the present embodiment in the nuclear power plant 1.

As illustrated in FIG. 3, the nuclear power plant 1 includes a nuclear reactor 201, the TBV 202, a generator 203, and a condenser 204. The nuclear reactor 201 is a device that generates electric power by continuing a chain reaction of nuclear fission while controlling the chain reaction. Steam generated accompanying generation of the electric power in the nuclear reactor 201 flows to the generator 203 and the condenser 204 via the TBV 202.

The TBV 202 is a valve that adjusts the amount of steam to be exhausted to the condenser 204, and, as the opening degree of the TBV 202 increases, the amount of steam flowing from the nuclear reactor 201 to the condenser 204 increases. For example, by performing control to increase the opening degree of the TBV 202 at a time of activation, stop, or the like of the nuclear reactor 201, it is possible to suppress the pressure in the nuclear reactor 201 from rising.

Furthermore, the steam flowing to the condenser 204 does not contribute to power generation, so that it is possible to adjust an output (electric power generation amount) of the generator by controlling the opening degree of the TBV 202 and controlling the amount of steam flowing to the condenser 204. However, the opening degree of the TBV 202 has the upper limit, and therefore it may not be possible to cause all the steam output from the nuclear reactor 201 to flow to the condenser 204.

The TBV 202 used in the existing nuclear power plants 1 in Japan can cause approximately 30% of the main steam from the nuclear reactor to flow to the condenser 204. The opening degree of the TBV 202 is adjusted according to a TBV adjustment signal Sg1. The TBV adjustment signal Sg1 is transmitted from a control system (not illustrated) of the nuclear power plant 1 based on information on a deviation between the output of the generator 203 and the electric power demand of the data center to make the deviation zero. Alternatively, when the calculation amount changeability determination result information If1 is transmitted from the plant control device 8 to the data center, the TBV adjustment signal Sg1 is transmitted from the plant control device 8 to the nuclear power plant 1.

### Hardware Configuration Example of Calculator

Next, a hardware configuration of a device for implementing functions of the plant control system 100 according to the present embodiment will be described with reference to FIG. 4. FIG. 4 is a block diagram illustrating the hardware configuration example of the plant control system 100. A calculator 50 illustrated in FIG. 4 is hardware used as a so-called computer.

The calculator 50 includes a control unit 51, a non-volatile storage 52, a display unit 53, an operation input unit 54, and a communication interface (I/F) 55 that are each connected to a bus B.

The control unit 51 includes a Central Processing Unit (CPU) 511, a Read Only Memory (ROM) 512, and a Random Access Memory (RAM) 513.

The CPU 511 reads from the ROM 512 a program code of software for implementing each function according to the present embodiment to develop in the RAM 513 and execute. Variables, parameters, and the like generated during arithmetic operation processing are temporarily written in the RAM 513.

Note that the control unit 51 may include a processing device such as a Micro-Processing Unit (MPU) instead of the CPU 511. Alternatively, the CPU and the MPU may be used in combination in the control unit 51.

As the non-volatile storage 52, for example, a Hard Disk Drive (HDD), a Solid State Drive (SSD), a flexible disk, an optical disk, a magneto-optical disk, a CD-ROM, a CD-R, a non-volatile memory card, or the like can be used. In addition to an Operating System (OS) and various parameters, a program for causing the calculator 50 to function and the like are recorded in this non-volatile storage 52. Note that the program may be stored in the ROM 512.

The display unit 53 is, for example, a monitor including a Liquid Crystal Display (LCD) or the like, and displays a result of processing performed by the calculator 50 and the like.

The operation input unit 54 includes, for example, a keyboard, a mouse, a touch sensor, and the like, generates an operation signal corresponding to a user's operation, and supplies the operation signal to the CPU 511.

Note that the display unit 53 and the operation input unit 54 may be integrally configured as a touch panel.

The program is stored in a form of a computer readable program code, and the CPU 511 sequentially executes an operation according to the program code. That is, the ROM 512 or the non-volatile storage 52 is used as an example of a computer-readable non-transitory recording medium in which the program to be executed by the computer has been stored.

For example, a Network Interface Card (NIC) or the like is used as the communication I/F 55, and various data can be transmitted and received to and from an external device via a network or a communication line.

### Calculation Amount Changeability Determination Processing of Calculation Amount Changeability Determination Unit

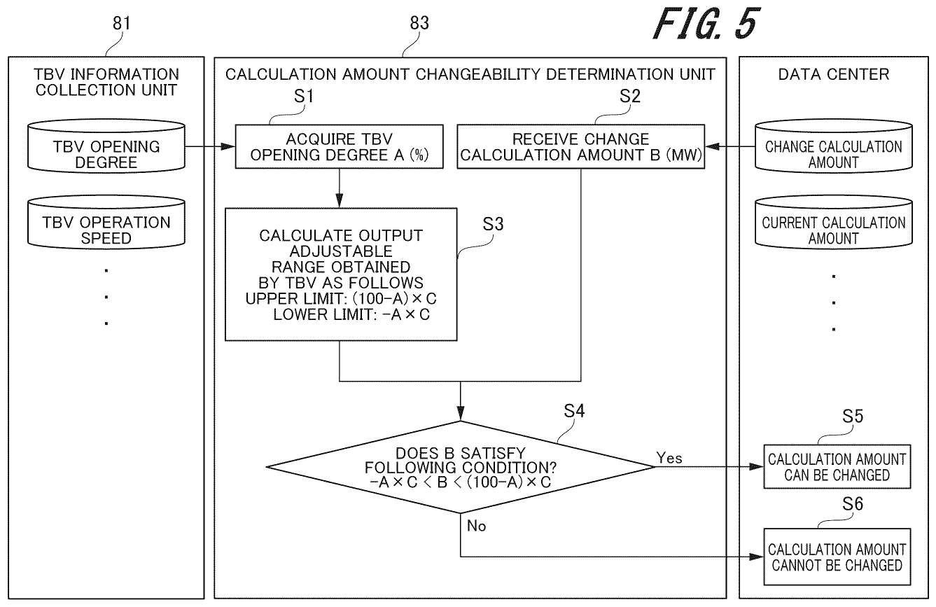

Next, calculation amount changeability determination processing of the calculation amount changeability determination unit 83 of the plant control device 8 will be described with reference to FIG. 5. FIG. 5 is a flowchart illustrating an example of a procedure of the calculation amount changeability determination processing of the calculation amount changeability determination unit 83.

First, the calculation amount changeability determination unit 83 acquires information on a TBV opening degree A (%) from the TBV information collection unit 81 (step S1). The TBV opening degree A (%) is a value indicating the magnitude of the opening degree of the TBV 202 (see FIG. 4) at a point of time, and can take, for example, a numerical value of 0 to 100 as the value of the TBV opening degree A (%). Note that the unit of the TBV opening degree is not limited to “%”, and may be indicated by a numerical value of 0 to 1 or the like indicating the opening degree.

Next, the calculation amount changeability determination unit 83 receives information on a change calculation amount from the consumer (data center) (step S2). More specifically, the calculation amount changeability determination unit 83 receives information on B (MW) from the consumer as the change calculation amount (an example of the change amount of the calculation amount). The change calculation amount B (MW) is an electric power consumption amount (an example of predicted electric power consumption amount) that fluctuates accompanying change of the calculation amount in the data center. Note that conversion from the calculation amount into the predicted electric power consumption amount may be performed by the calculation amount changeability determination unit 83 side. Furthermore, the processing in step S1 and the processing in step S2 may be performed temporally reversely, or may be performed substantially simultaneously.

Next, the calculation amount changeability determination unit 83 calculates an output adjustable range of electric power by adjusting the opening degree of the TBV 202 (step S3). Note that, since the unit of the TBV opening degree is “%” and the unit of the change calculation amount is “MW”, it is necessary to integrate the units to compare the TBV opening degree and the change calculation amount. Therefore, the calculation amount changeability determination unit 83 converts into units of MW the calculation amount that can be changed by adjusting the TBV opening degree, and uses the converted calculation amount as an index for determining whether the TBV can be opened or closed. More specifically, the calculation amount changeability determination unit 83 calculates the upper limit of the adjustable range of the output of the nuclear power plant 1 obtained by opening/closing control of the TBV 202 using following equation (1).

$$Upper limit value of output adjustment range obtained by TBV = ( 100 - A ) \times C ( MW ) \qquad Equation ( 1 )$$

In above equation (1), “C” represents a rated output (MW) of nuclear power generation.

Next, the calculation amount changeability determination unit 83 calculates a lower limit value of the adjustable range of the output of the nuclear power plant 1 obtained by the opening/closing control of the TBV 202 using following equation (2).

$$Lower limit value of output adjustment range obtained by TBV = A \times C ( MW ) \qquad Equation ( 2 )$$

Next, the calculation amount changeability determination unit 83 compares the upper limit value obtained by above equation (1), and the lower limit value obtained by above equation (2) and the change calculation amount B (MW) using following equation (3). Furthermore, the calculation amount changeability determination unit 83 determines whether or not the change calculation amount B satisfies the condition expressed in equation (3) (step S4).

$$- A \times C < B < ( 100 - A ) \times C \qquad Equation ( 3 )$$

In a case where it is determined that the change calculation amount B satisfies the condition expressed in above equation (3) (YES in step S3), the calculation amount changeability determination unit 83 determines that adjustment can be performed by opening and closing of the TBV 202, and outputs a determination result indicating that the calculation amount can be changed to the data center (step S5). On the other hand, in a case where it is determined that the change calculation amount B does not satisfy the condition expressed in above equation (3) (NO in step S3), the calculation amount changeability determination unit 83 outputs to the data center a determination result indicating that the calculation amount cannot be changed (step S6). After the processing in step S5 or step S6, the calculation amount changeability determination processing of the calculation amount changeability determination unit 83 ends. Note that the present embodiment has cited the example where, when it is determined that the change calculation amount B does not satisfy the condition expressed in above equation (3), the calculation amount changeability determination unit 83 outputs the determination result indicating that the calculation amount cannot be changed. However, the present invention is not limited thereto. For example, the calculation amount changeability determination unit 83 may output to the data center a determination result indicating permission to change the calculation amount within a range satisfying the condition expressed in above (3).

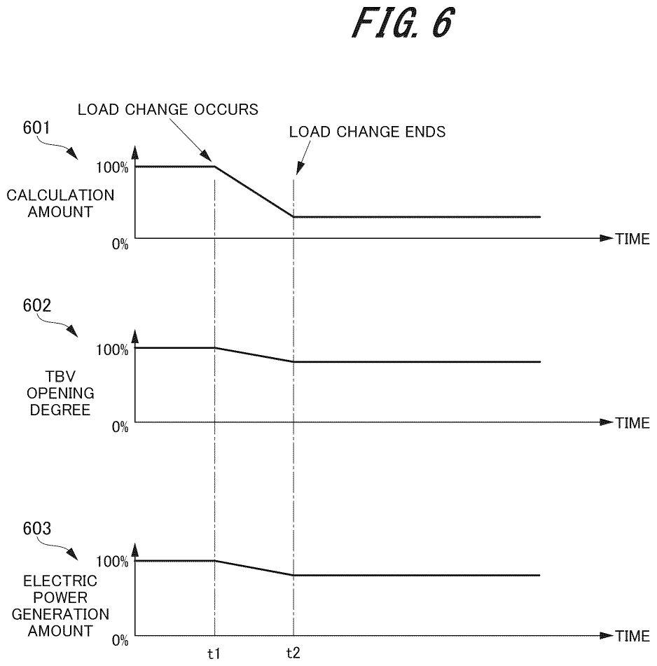

FIG. 6 is a graph showing temporal changes of a calculation amount 601 of the data center, an opening degree 602 of the TBV, and an electric power generation amount 603 of the nuclear power plant 1 in a case where the calculation amount is changed in step S5 in FIG. 5, that is, in a case where the output is changed by opening or closing the TBV.

FIG. 6 is a graph showing a transition of the calculation amount 601 of the data center, FIG. 6 is also a graph showing a transition of the TBV opening degree, and FIG. 6 is also a graph showing a transition of the electric power generation amount of the nuclear power plant 1. In FIG. 6, each of the vertical axes represents the calculation amount of the data center, the TBV opening degree, the electric power generation amount, and the horizontal axis represents the time.

When load change occurs at a point of a time t1, the calculation amount 601 of the data center decreases as illustrated in FIG. 6. Furthermore, at the same time t1, the TBV opening degree decreases as illustrated in FIG. 6. Furthermore, the TBV opening degree continues decreasing until the opening degree of the TBV 202 reaches the opening degree corresponding to the calculation amount of the data center. Furthermore, as illustrated in FIG. 6, as the TBV opening degree lowers, the electric power generation amount 603 of the nuclear power plant 1 also lowers.

Control for causing each transition illustrated in FIG. 6 is performed for the purpose of matching the electric power generation amount and the electric power load 5 of the data center, yet this control is continuously performed until a time t2 at which change of the load ends. By performing such control, it is possible to perform TBV opening/closing control of the nuclear power plant 1 matching load fluctuations of the data center.

According to the above-described first embodiment, consumers such as data centers that use electric power supplied from the nuclear power plant 1 can appropriately determine whether or not electric power demands can be changed.

### 2. Second Embodiment

Next, the second embodiment of the present invention will be described. In the above-described first embodiment, the calculation amount changeability determination unit 83 of the plant control device 8 determines whether or not the calculation amount can be changed based on the information on the TBV opening degree and information on the change calculation amount of the data center. However, depending on the opening degree of the TBV 202 at a point of time, a situation may occur in which the change calculation amount B does not satisfy the condition of above equation (3) only if the electric power generation amount in the nuclear power plant 1 is adjusted. In such a case, the nuclear power plant 1 cannot cope with fluctuation of the calculation amount in the data center.

Accordingly, in the second embodiment, even in a case where the change calculation amount does not satisfy the condition of equation (3), a calculation amount changeability determination unit 83 receives part of electric power from an external electric power system 4 to cope with fluctuation of a calculation amount in a data center.

### Configuration Example of Plant Control System

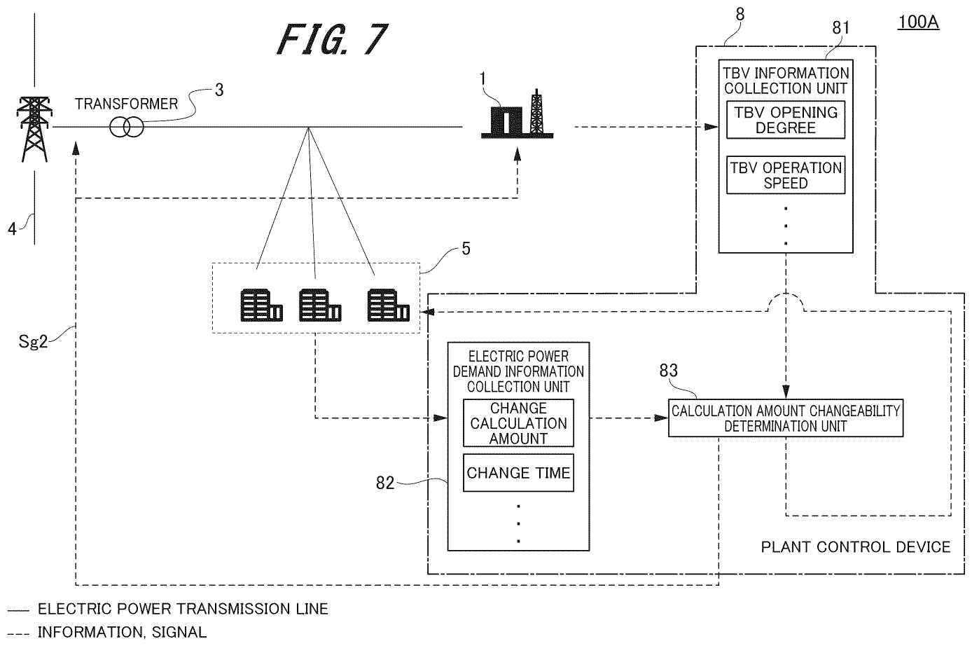

FIG. 7 is a diagram illustrating a schematic configuration example of a plant control system 100A according to the second embodiment. The plant control system 100A illustrated in FIG. 7 differs from the plant control system 100 illustrated in FIG. 2 in that the calculation amount changeability determination unit 83 transmits a control signal Sg2 to a transformer 3 and a device such as an unillustrated switching station.

The control signal Sg2 indicates either a signal for procuring part of electric power from the external electric power system 4, or a signal for transmitting electric power generated by a nuclear power plant 1 to the external electric power system 4. The control signal Sg2 for procuring part of electric power from the external electric power system 4 is, for example, a signal for instructing to change the switching station to an open state. Since the other components are the same as the components illustrated in FIG. 2, overlapping description will be omitted.

### Calculation Amount Changeability Determination Processing of Calculation Amount Changeability Determination Unit

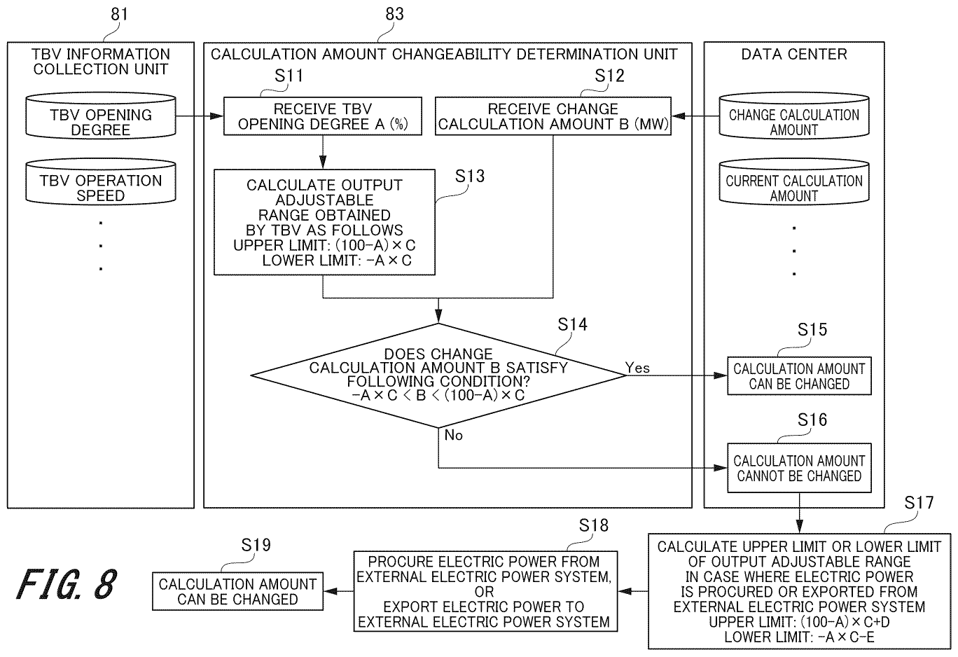

Next, calculation amount changeability determination processing of the calculation amount changeability determination unit 83 of a plant control device 8 according to the second embodiment will be described with reference to FIG. 8. FIG. 8 is a flowchart illustrating an example of a procedure of the calculation amount changeability determination processing of the calculation amount changeability determination unit 83.

Since step S11 to step S15 in FIG. 8 are the same as step S1 to step S5 in the flowchart illustrated in FIG. 5, redundant description will be omitted.

Here, processing after the calculation amount changeability determination unit 83 notifies the data center of the information indicating that the calculation amount cannot be changed in step S16 will be described.

The calculation amount changeability determination unit 83 having received a notification indicating that the calculation amount cannot be changed calculates an upper limit value of the adjustable range of the output of the nuclear power plant 1 (output adjustable range) obtained by opening/closing control of the TBV 202 when the electric power is procured from the external electric power system 4, or a lower limit value of the output adjustable range obtained by the opening/closing control of the TBV 202 when the electric power is exported to (interchanged with) the external electric power system 4 (step S17). The calculation amount changeability determination unit 83 calculates the upper limit value of the output adjustable range of the nuclear power plant 1 according to following equation (4), and calculates the lower limit value of the output adjustable range according to following equation (5).

$$Upper limit value of output adjustment range obtained by TBV opening / closing control and electric power procurement = ( 100 - A ) \times C + D ( MW ) \qquad Equation ( 4 )$$

$$Lower limit value of output adjustment range obtained by TBV opening / closing control and electric power export ( interchange ) = - A \times C - E ( MW ) \qquad Equation ( 5 )$$

“D” in above equation (4) represents a procured electric power amount (MW) to be received from the external electric power system 4, and “E” in above equation (5) represents an electric power export amount (MW) to be transmitted to the external electric power system 4. The procured electric power amount D is obtained as a difference between “(100−A)×C” that is an output adjustment range obtained by TBV opening/closing control, and a change calculation amount B. Furthermore, the electric power export amount E is obtained as a difference between “−A×C” that is an output adjustment range obtained by TBV opening/closing control, and the change calculation amount B.

Furthermore, the calculation amount changeability determination unit 83 procures the procured electric power amount D from the external electric power system 4, or exports the electric power export amount E to the external electric power system 4 (step S18). Next, the calculation amount changeability determination unit 83 outputs to the data center a determination result indicating that the calculation amount can be changed (step S19). After the processing in step S19, the calculation amount changeability determination processing of the calculation amount changeability determination unit 83 ends.

According to the above-described second embodiment, by compensating for load fluctuation that cannot be coped by TBV opening/closing control by procuring the electric power from the external electric power system 4, it is possible to cope with the load fluctuation in the data center. Furthermore, by exporting to the external electric power system 4 surplus electric power generated even when TBV opening degree control is performed, it is possible to effectively utilize the surplus electric power.

Note that a price of electric power (external power supply) procured by the nuclear power plant 1 from the external electric power system 4 generally differs depending on a time zone. More specifically, the price of the external power supply tends to be relatively low in a daytime time zone such as 12:00 to 17:00, and thereafter tends to increase toward midnight.

Accordingly, the calculation amount changeability determination unit 83 may perform calculation amount changeability processing referring to the information on the price of the external power supply in each time zone, too.

### 3. Third Embodiment

Next, the third embodiment of the present invention will be described. The above-described first embodiment and second embodiment have cited the examples where TBV opening/closing control is performed in response to the information (change calculation amount) on load fluctuation in the data center alone. However, the TBV 202 is originally a facility for adjusting an output of electric power when a disturbance such as a failure occurs in the external electric power system 4.

More specifically, the TBV 202 has a function of adjusting a rotation frequency of a generator in a nuclear power plant 1 to a system frequency by automatically opening and closing in accordance with fluctuations of a voltage, a frequency, and the like of the external electric power system 4. However, when TBV opening degree control is performed in accordance with the load fluctuation of the data center, there may be no margin for adjusting the TBV opening degree when a system failure occurs. A plant control device 8 according to the present embodiment performs calculation amount changeability determination processing by taking a behavior of the TBV 202 at the time of occurrence of the system failure into account, too.

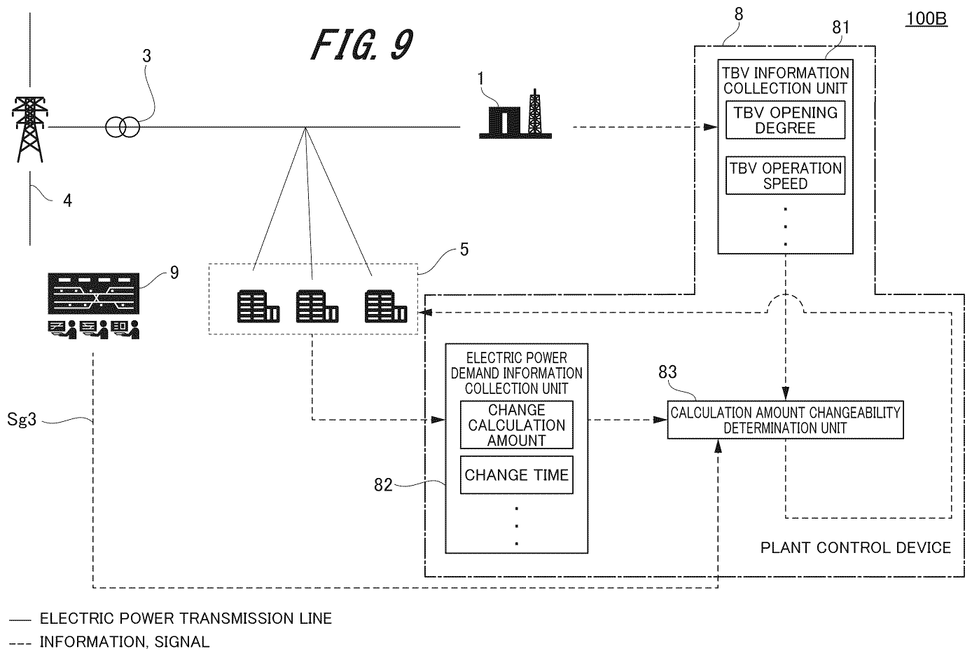

FIG. 9 is a diagram illustrating a schematic configuration example of a plant control system 100B according to the third embodiment. The plant control system 100B illustrated in FIG. 9 differs from the plant control system 100 illustrated in FIG. 2 in that the calculation amount changeability determination unit 83 receives a control signal Sg3 for instructing the TBV opening degree from a central load dispatching office 9, and determines whether or not a calculation amount can be changed, based on the control signal Sg3 and a change calculation amount B. Since the other components are the same as the components illustrated in FIG. 2, overlapping description will be omitted.

### Calculation Amount Changeability Determination Processing of Calculation Amount Changeability Determination Unit

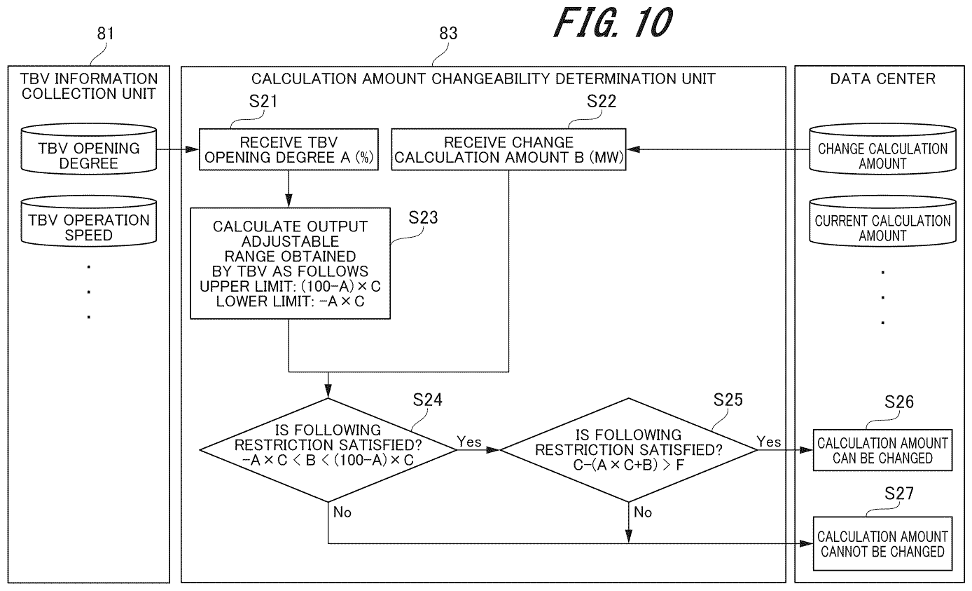

Calculation amount changeability determination processing of a calculation amount changeability determination unit 83 of the plant control device 8 according to the third embodiment will be described with reference to FIG. 10. FIG. 10 is a flowchart illustrating an example of a procedure of the calculation amount changeability determination processing of the calculation amount changeability determination unit 83.

Since step S21 to step S24, and step S26 and step S27 in FIG. 10 are the same as step S1 to step S4, and step S5 and step S6 in the flowchart illustrated in FIG. 5, overlapping description will be omitted.

FIG. 10 exemplifies the calculation amount changeability determination processing of the calculation amount changeability determination unit 83 in a case where the control signal Sg3 including an instruction to increase the TBV opening degree is received from the central load dispatching office 9.

In step S25, the calculation amount changeability determination unit 83 determines whether or not it is possible to cope with change of the calculation amount of a data center by TBV opening/closing control based on a calculation result of following equation (6).

$$C - ( A \times C + B ) > F \qquad Equation ( 6 )$$

A first term (“C”) on the left side of above equation (6) is a rated output of nuclear power generation. A parenthesis in a second term on the left side indicates a load increase of the data center, that is, an output (power generation amount) from a nuclear power plant in a case where the change calculation amount B is taken into consideration. Furthermore, “F” on the right side of above equation (6) represents an output adjustable value obtained by TBV opening/closing control.

When above equation (6) is satisfied, that is, when the output from the nuclear power plant 1 for which the change calculation amount B has been taken into account is larger than the output adjustable value F obtained by the TBV opening/closing control, the calculation amount changeability determination unit 83 determines that it is possible to cope with change of the calculation amount of the data center by performing the TBV opening/closing control.

Note that, when receiving the control signal Sg3 for instructing to decrease the TBV opening degree from the central load dispatching office 9, the calculation amount changeability determination unit 83 determines based on the calculation result of following equation (7) whether or not it is possible to cope with change of the calculation amount of the data center by performing the TBV opening/closing control.

$$C \times A - B > F \qquad Equation ( 7 )$$

The left side of above equation (7) indicates the electric power generation amount of the nuclear power plant 1 when the output is lowered in accordance with the change calculation amount B. When above equation (7) is satisfied, that is, when the output from the nuclear power plant 1 matching the change calculation amount B is larger than the output adjustable value F obtained by the TBV opening/closing control, the calculation amount changeability determination unit 83 determines that it is possible to cope with change of the calculation amount of the data center by performing the TBV opening/closing control.

According to the above-described third embodiment, it is possible to cope with load (calculation amount) fluctuations in the data center at normal times while securing the degree of freedom of the TBV opening degree necessary for improving stability of the electric power generation amount at a time of a system failure.

### Setting Screen of Output Adjustable Value Obtained by TBV Opening/Closing Control

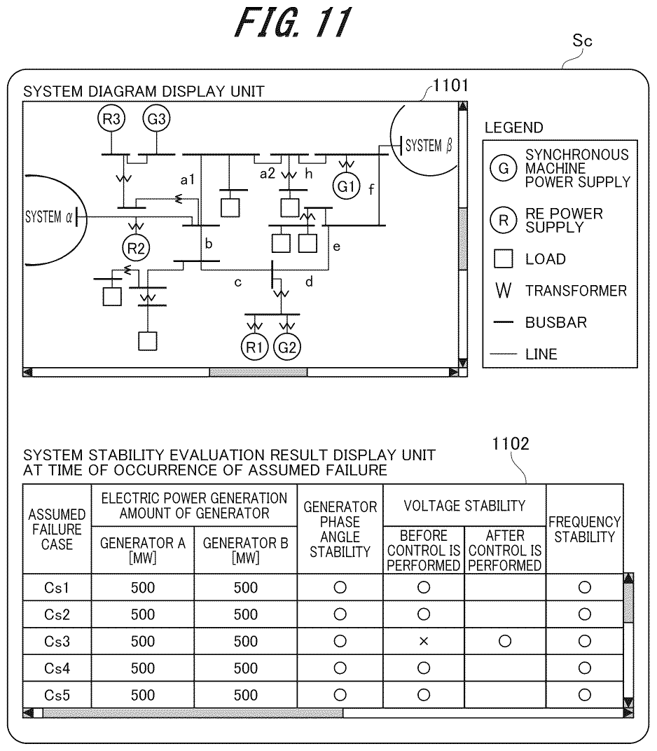

Next, an output adjustable value setting screen Sc displayed on a display unit 53 (see FIG. 4) of the central load dispatching office 9 will be described with reference to FIG. 11. FIG. 11 is a diagram illustrating a configuration example of the output adjustable value setting screen Sc. The output adjustable value setting screen Sc is a screen for setting the value of the TBV opening degree to be included in the control signal Sg3.

As illustrated in FIG. 11, the output adjustable value setting screen Sc includes a system diagram display unit 1101 and a system stability evaluation result display unit 1102 at a time of occurrence of an assumed failure.

In the system diagram display unit 1101, arrangement of a synchronous generator (illustrated as a “synchronous machine power supply” in FIG. 11), a renewable energy power supply (illustrated as a “RE power supply” in FIG. 11), and a load related to the external electric power system 4, and information of a transformer, a busbar, and a line that connect these components are illustrated in FIG. 11. FIG. 11 illustrates an example where there are a “system α” and a “system β” as the external electric power systems 4.

The system stability evaluation result display unit 1102 at the time of occurrence of the system failure displays an evaluation result of system stability in a case where the system failure occurs in an electric power system illustrated in the system diagram display unit 1101. Examples of indices of the evaluation result include a phase angle, a voltage, a frequency, and the like of the generator.

In the example illustrated in FIG. 11, the system stability evaluation result display unit 1102 at the time of occurrence of the system failure includes items of an “assumed failure case”, an “electric power generation amount of generator”, a “generator phase angle”, a “voltage”, and a “frequency”.

In the item of the “assumed failure case”, information on identifiers (Cs1 to Cs5) associated with respective failure cases of the assumed system failure is displayed. Examples of assumed failure cases include disconnection of an electric power transmission line, a decrease in voltage due to contact between the disconnected electric power transmission line and the ground, detachment of a power supply, and the like.

In the item of the “electric power generation amount of generator”, information on the electric power generation amount of each generator (nuclear power plant) at a point of time is displayed. In the example illustrated in FIG. 11, information on the electric power generation amounts of the two generators of a “generator A” and a “generator B” is illustrated.

In the item of the “generator phase angle stability”, information on stability of an angle indicating a relative position between a rotor shaft and a generated magnetic flux shaft (both not illustrated) of the generator is displayed.

In the item of the “voltage stability”, information on stability of the voltage before and after TBV opening/closing control is performed is displayed. In the item of the voltage stability, “×” is displayed when, for example, the voltage lowers due to a system failure, and “○” is displayed when stability of the voltage is expected even at a time of the system failure.

In the item of the “frequency stability”, information on stability of the frequency of the electric power generated by the generator is displayed. In the item of the frequency stability, “×” is displayed when, for example, the frequency lowers or rises due to a system failure, and “○” is displayed when the stability of the frequency is expected even at the time of the system failure.

By checking the output adjustable value setting screen Sc illustrated in FIG. 11, a person in charge of the central load dispatching office 9 can determine whether or not it is possible to stabilize the system by adjusting the TBV opening degree.

Note that each of the above-described embodiments has cited the example where the consumer is the data center. However, the present invention is not limited thereto. The consumer of the nuclear power plant 1 may be a consumer other than the data center as long as the consumer has characteristics that a load fluctuates frequently and a load fluctuation speed is fast.

Furthermore, each of the above-described embodiments has cited the example where the facility at a supply source of electric power to a consumer such as the data center is the nuclear power plant. However, the present invention is not limited thereto. As long as the facility handles energy whose output can be adjusted by TBV opening/closing control, the facility may be, for example, another facility such as a thermal power plant.

Furthermore, the above-described embodiments describe the configurations of the device and the system in detail and specifically to clearly explain the present invention, and are not necessarily limited to those including all the described components.

Furthermore, control lines or information lines indicated by solid lines in FIGS. 2 to 4, 7, and 9 indicate lines that are considered to be necessary for description, and do not necessarily indicate all control lines or information lines for a product. It may be considered that almost all the components are actually connected with each other.

What is claimed is:

1. A plant control device comprising:
a turbine bypass valve information collection unit that collects information on an opening degree of a turbine bypass valve in a power plant;
an electric power demand information collection unit that collects information on an electric power demand of a consumer that uses electric power generated by the power plant; and
an electric power demand changeability determination unit that determines whether or not the electric power demand of the consumer can be changed, based on the information on the opening degree of the turbine bypass valve and the information on the electric power demand, and outputs a determination result to the consumer.

2. The plant control device according to claim 1, wherein
the information on the electric power demand collected by the electric power demand information collection unit includes at least information on a change amount of the electric power demand in a case where the electric power demand is changed.

3. The plant control device according to claim 1, wherein
the electric power demand fluctuates depending on a calculation amount of calculation executed by the consumer, and
a change amount of the electric power demand is indicated by the change amount of the calculation amount or a predicted electric power consumption amount of the consumer that fluctuates accompanying change of the calculation amount.

4. The plant control device according to claim 3, wherein
when determining that the predicted electric power consumption amount is a value within a range of an adjustment range of an electric power generation amount of the power plant obtained by opening degree control of the turbine bypass valve, the electric power demand changeability determination unit determines that the calculation amount can be changed.

5. The plant control device according to claim 4, wherein
the electric power demand changeability determination unit calculates a value as an upper limit value of the adjustment range of the electric power generation amount of the power plant obtained by the opening degree control of the turbine bypass valve when the calculation amount is changed to increase, and determines that the calculation amount can be increased when the predicted electric power consumption amount is smaller than the calculated upper limit value of the adjustment range, the value being obtained by multiplying a rated output of the power plant on a difference between the opening degree of the turbine bypass valve at a point of time and an upper limit value of the opening degree of the turbine bypass valve.

6. The plant control device according to claim 4, wherein
the electric power demand changeability determination unit calculates a value as a lower limit value of the adjustment range of the electric power generation amount of the power plant obtained by the opening degree control of the turbine bypass valve when the calculation amount is changed to decrease, and determines that the calculation amount can be decreased when the predicted electric power consumption amount is larger than the calculated lower limit value of the adjustment range, the value being obtained by multiplying a rated output of the power plant on a value obtained by setting to minus a polarity of the opening degree of the turbine bypass valve at a point of time.

7. The plant control device according to claim 4, wherein
the electric power demand changeability determination unit calculates a total value when the calculation amount is changed to increase and when the predicted electric power consumption amount takes a value larger than a calculated upper limit value of the adjustment range, and determines that the calculation amount can be increased when the predicted electric power consumption amount is smaller than the total value, the total value being a total value of a value obtained by multiplying a rated output of the power plant on a difference between the opening degree of the turbine bypass valve at a point of time and an upper limit value of the opening degree of the turbine bypass valve, and an electric power amount that can be procured from an external electric power system.

8. The plant control device according to claim 4, wherein
the electric power demand changeability determination unit calculates a subtracted value when the calculation amount is changed to decrease and when the predicted electric power consumption amount takes a value smaller than a calculated lower limit value of the adjustment range, and determines that the calculation amount can be decreased when the predicted electric power consumption amount is larger than the subtracted value, the subtracted value being a value obtained by subtracting an electric power amount that can be interchanged with and procured to an external electric power system from a value obtained by multiplying a rated output of the power plant on a value obtained by setting to minus a polarity of the opening degree of the turbine bypass valve at a point of time.

9. The plant control device according to claim 4, wherein
when it is expected to increase the opening degree of the turbine bypass valve and increase the electric power generation amount of the power plant to cope with a disturbance that influences an external electric power system, and when the calculation amount is changed to increase, the electric power demand changeability determination unit calculates a value, and determines that the calculation amount can be increased when the calculated value is larger than the power generation amount that is expected to increase, the value being obtained by subtracting from a rated output of the power plant on a value obtained by adding the predicted electric power consumption amount to a value obtained by multiplying the opening degree of the turbine bypass valve at a point of time and the rated output of the power plant.

10. The plant control device according to claim 4, wherein
when it is expected to decrease the opening degree of the turbine bypass valve and decrease the electric power generation amount of the power plant to cope with a disturbance that influences an external electric power system, and when the calculation amount is changed to decrease, the electric power demand changeability determination unit calculates a value, and determines that the calculation amount can be decreased when the calculated value is larger than the electric power generation amount that is expected to decrease, the value being obtained by subtracting the predicted electric power consumption amount from a value obtained by multiplying the opening degree of the turbine bypass valve at a point of time and a rated output of the power plant.

11. The plant control device according to claim 3, wherein
the power plant is a nuclear power plant, and the consumer is a data center that performs calculation that requires large electric power consumption.

12. A calculation amount changeability determination method comprising:
a step of, at a turbine bypass valve information collection unit, collecting information on an opening degree of a turbine bypass valve in a power plant;
a step of, at an electric power demand information collection unit, collecting information on an electric power demand of a consumer that uses electric power generated by the power plant; and
a step of, at an electric power demand changeability determination unit, determining whether or not the electric power demand of the consumer can be changed, based on the information on the opening degree of the turbine bypass valve and the information on the electric power demand, and outputting a determination result to the consumer.
